(19) United States
(12) Patent Application Publication
(10) Pub. No.: US 2021/0401069 A1
(43) Pub. Date: Dec. 30, 2021

(54) ARTICLE OF CLOTHING AND MANUFACTURING METHOD THEREOF

(71) Applicant: Regina Miracle International (Group) Limited, Kwai Chung, Hong Kong (CN)

(72) Inventor: Zhenqiang LIU, Kwai Chung, Hong Kong (CN)

(21) Appl. No.: 17/281,476

(22) PCT Filed: Oct. 8, 2018
(86) PCT No.: PCT/CN2018/109324

§ 371 Date: Mar. 30, 2021

(51) Int. Cl. A41C 3/00; A41D 31/18

(52) U.S. Cl. CPC A41C 3/0014; A41D 31/185

(57) ABSTRACT

An article of clothing and a method of manufacturing thereof is disclosed. The article of clothing comprises a first fabric layer and a second fabric layer. The article of clothing further comprises an elastic mesh. The elastic mesh is sandwiched between the first fabric layer and the second fabric layer. Herein, the elastic mesh has higher elasticity along a first direction as compared to a second direction thereof. The elastic mesh is heat sealed to at least one of the first fabric layer and the second fabric layer

### FIELD OF THE PRESENT DISCLOSURE

The present disclosure relates generally to articles of clothing, and in particular, to an article of clothing having higher elasticity along a first direction as compared to a second direction at least in a section thereof.

### BACKGROUND

Various garments, such as bras, T-shirts, pants, etc., incorporate elastic portions, for example around neck portion or in shoulder portion thereof. These elastic portions are capable of expanding and contracting, and thus may aid with supporting the garment against the body of a wearer. Conventionally, in order to allow for such expansion and contraction of the elastic portions, rubber material has been employed. Sometimes it is desired for the garments to have more elasticity along one direction as compared to another direction in order for the garment to fit the different sizes of different wearers. For instance, in trousers, a waist section usually needs enhanced elasticity along horizontal direction (or, the direction of stretching of the waist) as compared to vertical direction (or, the direction of length of the trouser), so as to make the trouser suitable for people of different body proportions.

Accordingly, there is a need of article of clothing with elastic portions which have higher elasticity along one direction as compared to other direction thereof, so as to make the article of clothing suitable for people of different body proportions.

### SUMMARY

In one aspect, an article of clothing is disclosed. The article of clothing comprises a first fabric layer and a second fabric layer. The article of clothing further comprises an elastic mesh sandwiched between the first fabric layer and the second fabric layer. The elastic mesh has higher elasticity along a first direction as compared to a second direction thereof.

In one or more embodiments, the elastic mesh comprises first threads arranged along the first direction and second threads arranged along the second direction, and wherein the first threads and the second threads crisscross each other to form the elastic mesh.

In one or more embodiments, the first threads are made of higher elasticity material and the second threads are made of comparatively lower elasticity material.

In one or more embodiments, the first threads are made of thermoplastic elastomers (TPE) material and the second threads are made of polyethylene (PE) material.

In one or more embodiments, the first threads have lower cross-sectional thickness as compared to the second threads.

In one or more embodiments, the second threads have 1.1 to 3 times of cross-sectional thickness as compared to the first threads.

In one or more embodiments, the first threads and the second threads crisscross each other in a manner to form a plurality of rectangular openings in the elastic mesh, and wherein sides of each of the plurality of rectangular openings extending along the first direction are shorter as compared to sides of each of the plurality of rectangular openings extending along the second direction.

In one or more embodiments, each of the plurality of rectangular openings in the elastic mesh have dimensions substantially equal to one of 3 mm by 5.5 mm, 1.5 mm by 2.5 mm and 1 mm by 1.2 mm.

In one or more embodiments, the elastic mesh has 1.1 to 3 times higher elasticity along the first direction as compared to the second direction thereof

In one or more embodiments, the elastic mesh is heat sealed to one of the first fabric layer and the second fabric layer.

In one or more embodiments, the elastic mesh is heat sealed to both the first fabric layer and the second fabric layer, and thereby adheres the first fabric layer to the second fabric layer.

In another aspect, a method of manufacturing an article of clothing is disclosed. The method comprises providing a first fabric layer and a second fabric layer. The method further comprises providing an elastic mesh having higher elasticity along a first direction as compared to a second direction thereof. The method further comprises sandwiching the elastic mesh between the first fabric layer and the second fabric layer.

In one or more embodiments, the method further comprises hot pressing the elastic mesh between the first fabric layer and the second fabric layer.

In one or more embodiments, the elastic mesh is heat sealed to one of the first fabric layer and the second fabric layer.

In one or more embodiments, the elastic mesh is heat sealed to both the first fabric layer and the second fabric layer, and thereby adheres the first fabric layer to the second fabric layer.

In one or more embodiments, the elastic mesh comprises first threads arranged along the first direction and second threads arranged along the second direction, and wherein the first threads and the second threads crisscross each other to form the elastic mesh.

In one or more embodiments, the first threads are made of higher elasticity material and the second threads are made of comparatively lower elasticity material.

In one or more embodiments, the first threads have lower cross-sectional thickness as compared to the second threads.

In one or more embodiments, the first threads and the second threads crisscross each other in a manner to form a plurality of rectangular openings in the elastic mesh, and wherein sides of each of the plurality of rectangular openings extending along the first direction are shorter as compared to sides of each of the plurality of rectangular openings extending along the second direction.

In yet another aspect, a brassiere is disclosed. The brassiere comprises a pair of bra cups. The brassiere also comprises a pair of side wings joined to the pair of bra cups. One or more of the pair of bra cups and the pair of side wings comprises a first fabric layer and a second fabric layer. An elastic mesh is heat sealed to at least one of the first fabric layer and the second fabric layer, and sandwiched between the first fabric layer and the second fabric layer. The elastic mesh has higher elasticity along a first direction as compared to a second direction thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a more complete understanding of example embodiments of the present disclosure, reference is now made to the following descriptions taken in connection with the accompanying drawings in which:

FIG. 1 illustrates a diagrammatic view of an article of clothing with an elastic portion therein, in accordance with one or more embodiments of the present disclosure;

FIG. 2A illustrates a diagrammatic view of the article of clothing with the elastic portion disposed in the pair of bra cups therein, in accordance with one or more embodiments of the present disclosure;

FIG. 2B illustrates a diagrammatic view of the article of clothing with the elastic portion disposed in the pair of side wings therein, in accordance with one or more embodiments of the present disclosure;

FIG. 3A illustrates a diagrammatic view of a planar sheet of the elastic portion, in accordance with one or more embodiments of the present disclosure;

FIG. 3B illustrates an exploded view of the planar sheet of the elastic portion, in accordance with one or more embodiments of the present disclosure;

FIG. 4 illustrates a molding setup for manufacturing the elastic portion, in accordance with one or more embodiments of the present disclosure;

FIG. 5A illustrates the pair of bra cups as formed, in accordance with one or more embodiments of the present disclosure;

FIG. 5B illustrates one of the pair of bra cups showing arrangement of the elastic portion therein, in accordance with one or more embodiments of the present disclosure; and

FIGS. 6-10 illustrate diagrammatic views of various exemplary articles of clothing, in accordance with one or more embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

The embodiments are described herein for illustrative purposes and are subject to many variations. It is understood that various omissions and substitutions of equivalents are contemplated as circumstances may suggest or render expedient, but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Where there is reference to the word “layer” it is to be understood that it may have its common definition and, but not limited to that the layer could consist of one panel or may have regions that are defined by two or more panels that are joined and that may each be of a different characteristic (e.g. color, thickness, material, orientation, size).

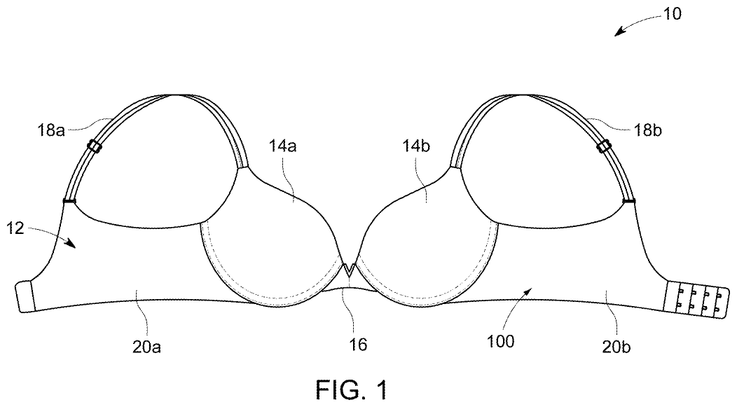

Referring to the drawings, FIG. 1 illustrates a diagrammatic view of an article of clothing 10, in accordance with one or more embodiments of the present disclosure. The article of clothing 10 may be any garment to be worn by a wearer. For example, the article of clothing 10 may be, but not limited to, a brassiere, a bra top, a sports top, a pantie, a T-shirt, a pant, and the like. In the exemplary illustration of FIG. 1, the article of clothing 10 is shown to be a brassiere. The article of clothing 10 includes a body structure 12 which defines shape of the article of clothing 10. In the exemplary article of clothing 10 of FIG. 1, the body structure 12 includes a pair of bra cups, with a first bra cup 14a and a second bra cup 14b. A center gore 16 is extending between and connects the first bra cup 14a and the second bra cup 14b. A pair of straps, including a first strap 18a and a second strap 18b are attached to peripheries of the first bra cup 14a and the second bra cup 14b, respectively. Further, a pair of side wings, including a first side wing 20a and a second side wing 20b are attached to the peripheries of the first bra cup 14a and the second bra cup 14b, respectively. In one or more examples, one or more fasteners 22 may be provided with one or more of the first side wing 20a and the second side wing 20b. It may be contemplated that the pair of straps 18a and 18b support the article of clothing 10, being the brassiere, on shoulders of the wearer, while the pair of side wings 20a and 20b support the article of clothing 10 around a torso of the wearer. In some examples, the pair of straps 18a and 18b may not be provided and only the pair of side wings 20a and 20b may support the article of clothing 10 on the wearer.

In the present embodiments, the article of clothing 10 includes an elastic portion 100 disposed in at least one section of the body structure 12 thereof. The elastic portion 100 allows the body structure 12 to expand and contract for fitting the article of clothing 10 to the user. According to embodiments of the present disclosure, the elastic portion 100 has a higher elasticity along a first direction as compared to a second direction thereof, as discussed in the subsequent paragraphs. Such configuration may be required for making the article of clothing 10 suitable for wearers with different body proportions, while providing support to the wearer. In the present embodiments, the article of clothing 10 may have one or more elastic portions 100 disposed at one or more regions therein.

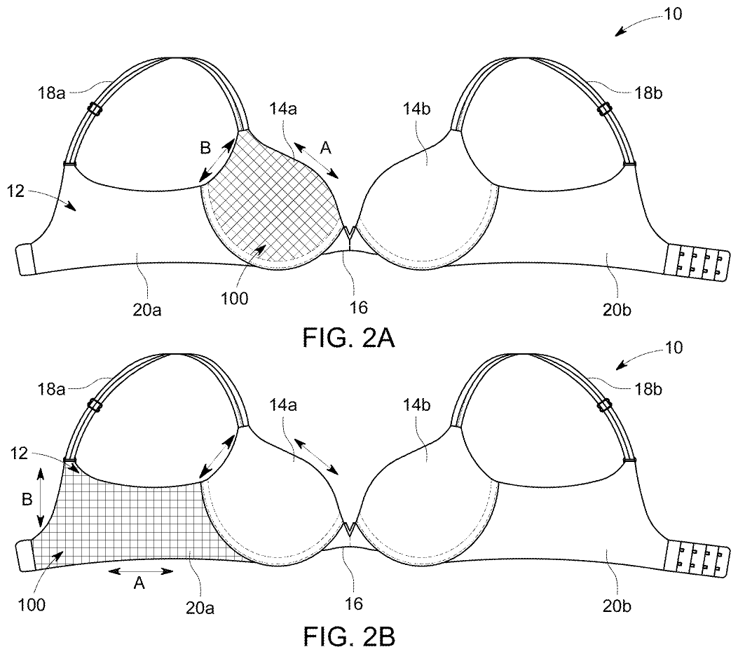

FIGS. 2A and 2B illustrate the article of clothing 10 (as illustrated in FIG. 1), in accordance with two different embodiments of the present disclosure. As illustrated, the article of clothing 10 includes the elastic portion 100 therein. The elastic portion 100 has a higher elasticity along a first direction ‘A’ as compared to a second direction ‘B’ thereof. For example, as illustrated in FIG. 2A, the pair of bra cups 14a and 14b are made of the elastic portions 100. Although FIG. 2A only shows the first bra cup 14a to be made of the elastic portion 100 (represented as hatched pattern), it shall be understood that the second bra cup 14b may also be made of the elastic portion 100. The elastic portion 100 allows the article of clothing 10 of FIG. 2A to be adapted to different chest types of the wearer by providing more elasticity along larger flanks of the bra cups 14a and 14b, while adding support by making the shorter flank of the bra cups 14a and 14b less elastic. Similarly, for example, as illustrated in FIG. 2B, the pair of side wings 20a and 20b are made of the elastic portions 100. Again although FIG. 2B only shows the first side wing 20a to be made of the elastic portion 100 (represented as hatched pattern), it shall be understood that the second side wing 20b may also be made of the elastic portion 100. The elastic portion 100 allows the article of clothing 10 of FIG. 2B to be adapted to different chest types of the wearer by providing more elasticity along horizontal direction of the side wings 20a and 20b, while adding support by making the side wings 20a and 20b less elastic along the vertical direction. It may be understood that the body structure 12 provides the external appearance to the article of clothing 10 and the incorporated elastic portions 100 allow the article of clothing 10 to be worn in a fitted manner. Further, it may be contemplated by a person skilled in the art that the article of clothing 10 may have both the pair of bra cups 14a and 14b as well as the pair of side wings 20a and 20b made of the elastic portions 100 (not shown in the accompanying drawings) without departing from the scope of the present disclosure.

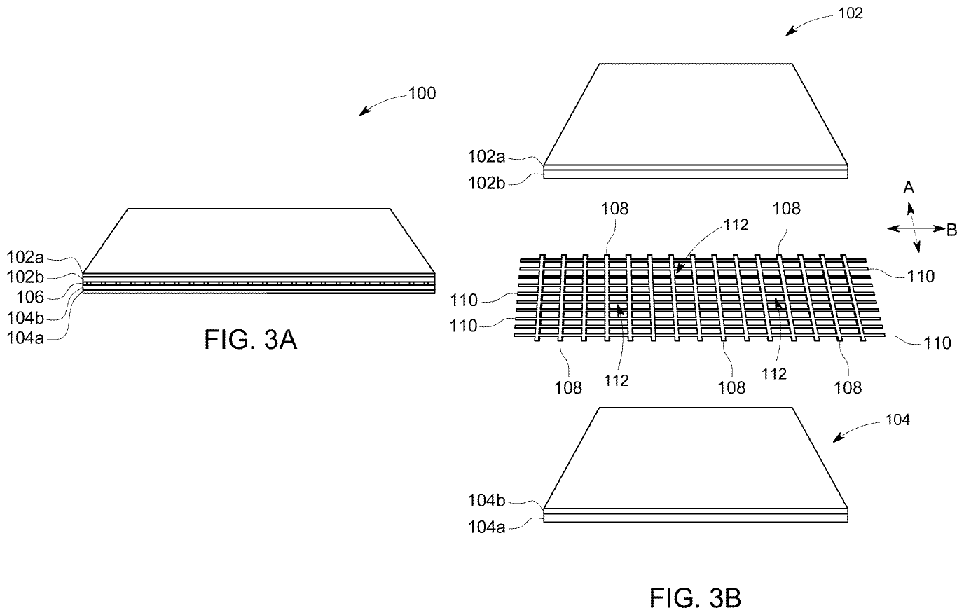

FIG. 3A illustrates a planar sheet of the elastic portion 100 which is utilized in the article of clothing 10. It shall be appreciated that such planar sheet of the elastic portion 100 can be molded into desired shape and trimmed (if required) to form the elastic portion 100 for use in the article of clothing 10. Further, FIG. 3B illustrates an exploded view of the planar sheet of the elastic portion 100 showing different layers therein, separated from each other. As illustrated in FIGS. 3A and 3B, the elastic portion 100 includes a first fabric layer 102 and a second fabric layer 104. In one or more embodiments of the present disclosure, the first fabric layer 102 includes a fabric sheet 102a and a foam sheet 102b. In such case, the fabric sheet 102a and the foam sheet 102b may be laminated and co-extensive with each other. Similarly, the second fabric layer 104 includes a fabric sheet 104a and a foam sheet 104b, and the fabric sheet 104a and the foam sheet 104b may be laminated and co-extensive with each other. The first fabric layer 102 and the second fabric layer 104 are arranged in the elastic portion 100 in a manner such that the corresponding foam sheets 102b and 104b are facing each other, and the fabric sheets 102a and 104a form outer surfaces of the elastic portion 100.

In the present examples, the fabric sheets 102a and 104a may be a product known by model number CMF-7440MU of Friendly Foundate Ltd. and having a make-up of approximately 80% Tactel and 20% Lycra, and a weight of about 190 g/sqm. Further, the foam sheets 102b and 104b are one of thermoplastic rubber (TPR), thermoplastic polyurethane (TPU), silicone, ethylene vinyl acetate (EVA), polyvinyl chloride (PVC) and polypropylene (PP). Preferably, the foam sheets 102b and 104b are of a polyurethane foam such as, for example, EL58-4S of Inoac Corporation which is a memory foam. In some examples, the fabric sheet and the foam sheet of the corresponding fabric layer may be laminated together using an adhesive, such as glue HM-1 of Forbo Swift Adhesives SA. The adhesive may be sprayed onto at least one of the opposing facing surfaces of the fabric sheet and the foam sheet. The adhesive may stick the fabric sheet and the foam sheet together when dry without heating, to form the corresponding first fabric layer 102 and the second fabric layer 104.

According to embodiments of the present disclosure, the elastic portion 100 further comprises an elastic mesh 106. The elastic mesh 106 is in the form of a net with plurality of openings therein. As illustrated, the elastic mesh 106 is sandwiched between the first fabric layer 102 and the second fabric layer 104 to complete the elastic portion 100. In one embodiment, the elastic mesh 106 is of the same dimensions as the first fabric layer 102 and the second fabric layer 104 such that the elastic mesh 106 is co-extensive (i.e. extends along entire surface areas) with the first fabric layer 102 and the second fabric layer 104. In other embodiment, the elastic mesh 106 may have smaller dimensions with respect to the first fabric layer 102 and the second fabric layer 104 such that the elastic mesh 106 extends only partially along surface areas of the first fabric layer 102 and the second fabric layer 104.

As discussed earlier, in the present embodiments, the elastic mesh 106 has higher elasticity along the first direction ‘A’ as compared to the second direction ‘B’ thereof. That is, in general, the elastic mesh 106 is more stretchable along one direction as compared to another direction along a plane of the elastic mesh 106. In one embodiment, the elastic mesh 106 has 1.1 to 3 times higher elasticity along the first direction ‘A’ as compared to the second direction ‘B’ thereof. In preferred embodiments, the elastic mesh 106 has about 2 to 3 times higher elasticity along the first direction ‘A’ as compared to the second direction ‘B’ thereof. In one or more embodiments, the first direction ‘A’ and the second direction ‘B’ are orthogonal to each other. In other examples, the first direction ‘A’ and the second direction ‘B’ may be disposed at an angle other than orthogonal to each other without any limitations. It may be appreciated that when the elastic portion 100 is utilized in the article of clothing 10, the first direction ‘A’ and the second direction ‘B’ of the elastic mesh 106 may be defined based on the orientation of the elastic portion 100 in the article of clothing 10.

As illustrated better in FIG. 3B, the elastic mesh 106 includes first threads 108 arranged along the first direction ‘A’ and second threads 110 arranged along the second direction . Herein, the first threads 108 and the second threads 110 crisscross each other to form the elastic mesh 106. In view of the above described embodiments, the first threads 108 and the second threads 110 may be orthogonally arranged with respect to each other; however, in other examples, the first threads 108 and the second threads 110 may be disposed at an angle other than orthogonal with respect to each other without any limitations. It may be understood that the first threads 108 and the second threads 110 may be weaved interlocking with each other to form the crisscross pattern by any suitable technique known in the art. Further, it may be understood that the density of the first threads 108 and the second threads 110 in the elastic mesh 106 may be based on the amount of stretching required from the elastic portion 100 in the article of clothing 10.

According to one embodiment, the first threads 108 are made of higher elasticity material and the second threads 110 are made of comparatively lower elasticity material, thus imparting the elastic mesh 106 higher elasticity along the direction of extension of the first threads 108 (i.e. the first direction ‘A’) as compared to the direction of extension of the second threads 110 (i.e. the second direction ‘B’). In one example, the first threads 108 are made of thermoplastic elastomers (TPE) material and the second threads 110 are made of polyethylene (PE) material. It may be appreciated that any two elastic materials suitable to be formed as threads and for use in an article of clothing with relatively different elasticities can be utilized for forming the elastic mesh 106, as long as the material with comparatively higher elasticity is used for forming the first threads 108 and the material with comparatively lower elasticity is used for forming the second threads 110.

Herein, thermoplastic elastomers (TPE), also sometimes referred to as thermoplastic materials or thermoplastic rubbers (TPR), are a class of copolymers or a physical mix of polymers (usually a plastic and a rubber) which consist of materials with both thermoplastic and elastomeric properties. Thermoplastic materials show advantages typical of both rubbery materials and plastic materials. The benefit of using thermoplastic materials is the ability to stretch to moderate elongations and return to its near original shape creating a longer life and better physical range than other materials. Examples of thermoplastic materials which are widely available in the market include, but not limited to, Hytrel, Dryflex, Mediprene, Kraton, Pibiflex, Sofprene, Laprene, Sofprene, Dryflex, Santoprene, Termoton, Solprene, etc., to name a few. Further, polyethylene (PE) is a thermoplastic polymer with variable crystalline structure. Polyethylene is light, versatile synthetic resin made from the polymerization of ethylene. Polyethylene is commonly categorized into one of several major compounds of which the most common include LDPE, LLDPE, HDPE, and Ultrahigh Molecular Weight Polypropylene. Other variants include Medium Density Polyethylene (MDPE), Ultra-low-molecular-weight polyethylene (ULMWPE or PE-WAX), High-molecular-weight polyethylene (HMWPE), High-density cross-linked polyethylene (HDXLPE), Cross-linked polyethylene (PEX or XLPE), Very-low-density polyethylene (VLDPE), and Chlorinated polyethylene (CPE).

According to another embodiment, the first threads 108 have lower cross-sectional thickness as compared to the second threads 110. As may be contemplated, in such case, the first threads 108 would generally have lesser amount of material as compared to the second threads 110 in the elastic mesh 106, thus imparting the elastic mesh 106 higher elasticity along the direction of extension of the first threads 108 (i.e. the first direction ‘A’) as compared to the direction of extension of the second threads 110 (i.e. the second direction ‘B’). In one example, the second threads 110 have 1.1 to 3 times of cross-sectional thickness as compared to the first threads 108. In preferred examples, the second threads 110 have about 2 to 3 times of cross-sectional thickness as compared to the first threads 108.

According to yet another embodiment, the first threads 108 and the second threads 110 crisscross each other in a manner to form a plurality of rectangular openings 112 (as shown in FIG. 3B) in the elastic mesh 106. The plurality of rectangular openings 112 are arranged such that sides of each of the plurality of rectangular openings 112 extending along the first direction ‘A’ are shorter as compared to sides of each of the plurality of rectangular openings 112 extending along the second direction ‘B’ . In other words, in general, for any sheet of elastic mesh 106, the overall or combined lengths of the first threads 108 is smaller than the overall or combined lengths of the second threads 110 therein. The first threads 108, by virtue of having overall or combined lengths smaller than the second threads 110, would generally have lesser material as compared to the second threads 110 in the elastic mesh 106 (considering other parameters remain the same), thus imparting the elastic mesh 106 higher elasticity along the direction of extension of the first threads 108 (i.e. the first direction ‘A’) as compared to the direction of extension of the second threads 110 (i.e. the second direction ‘B’). In one or more examples, each of the plurality of rectangular openings 112 in the elastic mesh 106 have dimensions substantially equal to one of 3 mm by 5.5 mm, 1.5 mm by 2.5 mm and 1 mm by 1.2 mm. For example, considering the case of the rectangular openings 112 having dimensions of 3 mm by 5.5 mm, it may be contemplated that the shorter side of the rectangular openings 112 with dimension of 3 mm would extend along the first direction ‘A’ and the longer side of the rectangular openings 112 with dimension of 5.5 mm would extend along the second direction ‘B’. It may be understood that the given dimensions are exemplary only and there could be other possible dimensions for the rectangular openings 112 without any limitations.

In an embodiment of the present disclosure, the fabric layers 102, 104 and the elastic mesh 106 are molded together using known heat molding techniques involving the application of heat and pressure to form the elastic portion 100. In one or more examples, the fabric layers 102, 104 and the elastic mesh 106 may be bonded or laminated during the molding process simply by the application of heat and pressure, or may additionally involve the use of an adhesive to facilitate bonding of the layers. The employed bonding techniques may depend largely on the nature of the fabric layers 102 and 104, e.g. leather, fabric, foam, etc. In one embodiment of the present disclosure, the first fabric layer 102, the second fabric layer 104 and the elastic mesh 106 are separately pre-molded and later joined together to form the elastic portion 100. The following paragraphs explain in detail the molding setup and processes for joining the fabric layers 102, 104 and the elastic mesh 106 together to form the elastic portion 100.

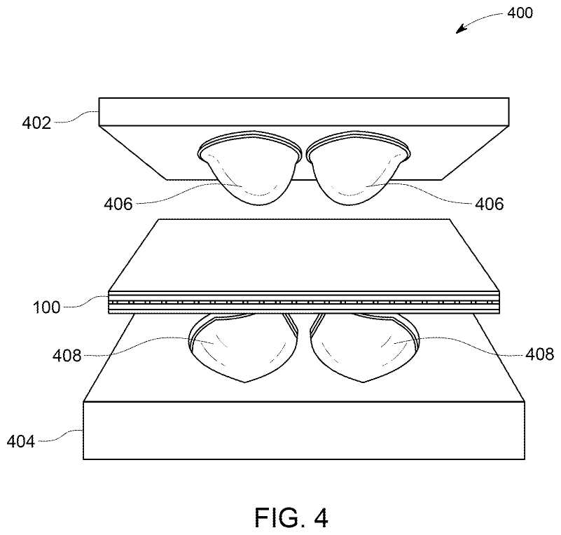

FIG. 4 illustrates a molding setup 400 for carrying out a method of manufacturing of the article of clothing 10 (or in this case a section thereof) by molding the fabric layers 102, 104 and the elastic mesh 106 together. In particular, the molding process carried by the molding setup 400 involves the molding of the fabric layers 102, 104 and the elastic mesh 106 simultaneously. As illustrated in FIG. 4, the molding setup 400 includes a first molding part 402 and a second molding part 404. The molding process takes place by arranging the elastic mesh 106 with respect to the first fabric layer 102 and the second fabric layer 104 such that the elastic mesh 106 is disposed between the first fabric layer 102 and the second fabric layer 104. Further, the first fabric layer 102 and the second fabric layer 104 may be arranged such that the corresponding foam sheets 102b and 104b may be facing and are joined with the elastic mesh 106 during the molding process.

In an embodiment, the molding process involves hot pressing the elastic mesh 106 between the first fabric layer 102 and the second fabric layer 104. The hot pressing is carried out such that the elastic mesh 106 is heat sealed to at least one of the first fabric layer 102 and the second fabric layer 104. In one example, the hot pressing is carried out such that the elastic mesh 106 is heat sealed to both the first fabric layer 102 and the second fabric layer 104. Thereby, the elastic mesh 106 adheres the first fabric layer 102 to the second fabric layer 104. For this purpose, the fabric layers 102, 104 and the elastic mesh 106 are put together as a bundle between the molding parts 402 and 404, and pressed thereby. In other examples, the elastic mesh 106 is heat sealed to only one of the first fabric layer 102 and the second fabric layer 104. For this purpose, only one of the fabric layers 102 and 104 (i.e. either the first fabric layer 102 or the second fabric layer 104) and the elastic mesh 106 are put together between the molding parts 402 and 404 and pressed therein to obtain a molded assembly, and later the other of the first fabric layer 102 or the second fabric layer 104 is stitched or fastened by other suitable means, such as ultrasonic welding, to the obtained molded assembly. In such case, the other of the first fabric layer 102 or the second fabric layer 104 would stay loose in the elastic portion 100, as may be desired for some configurations of the article of clothing 10. It may be appreciated that the elastic mesh 106 also provides support to one or more of the first fabric layer 102 and the second fabric layer 104, and further prevents breaking of the first fabric layer 102 to the second fabric layer 104 during the molding process.

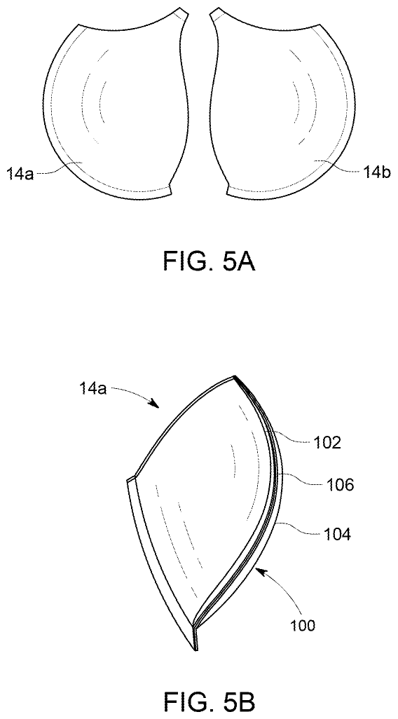

FIG. 5A illustrates the bra cups 14a and 14b obtained from the molding process (as described above) using the molding setup 400 of FIG. 4. Further, FIG. 5B illustrates one of the formed bra cups 14a with the elastic portion 100 having the first fabric layer 102, the elastic mesh 106 and the second fabric layer 104 therein. It may be contemplated by a person skilled in the art that some other types of molding setups may, similarly, be implemented for forming the pair of side wings 20a and 20b without departing from the scope of the present disclosure. Also, it will be appreciated that the formed bra cups 14a and 14b may be trimmed as required and subsequently stitched or fastened by other suitable means such as ultrasonic welding to the side wings 20a and 20b of the body structure 12, to complete the article of clothing 10 (as illustrated in FIG. 1).

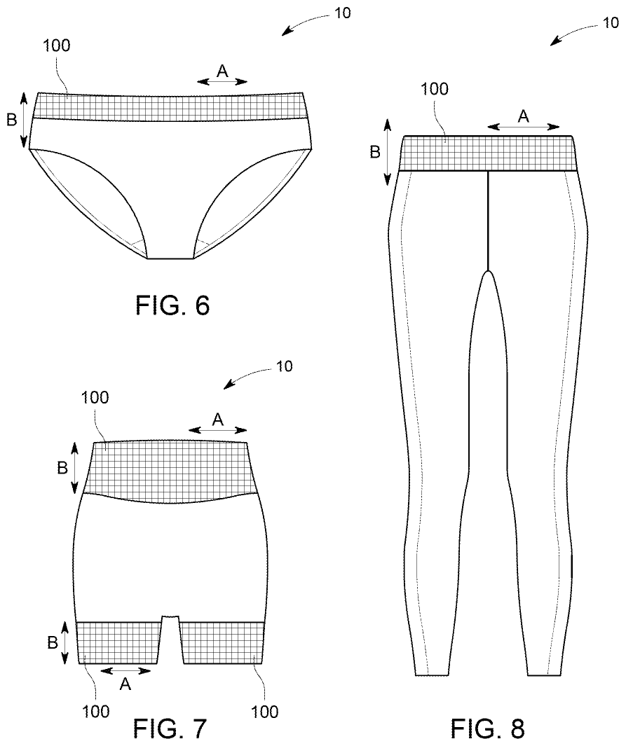

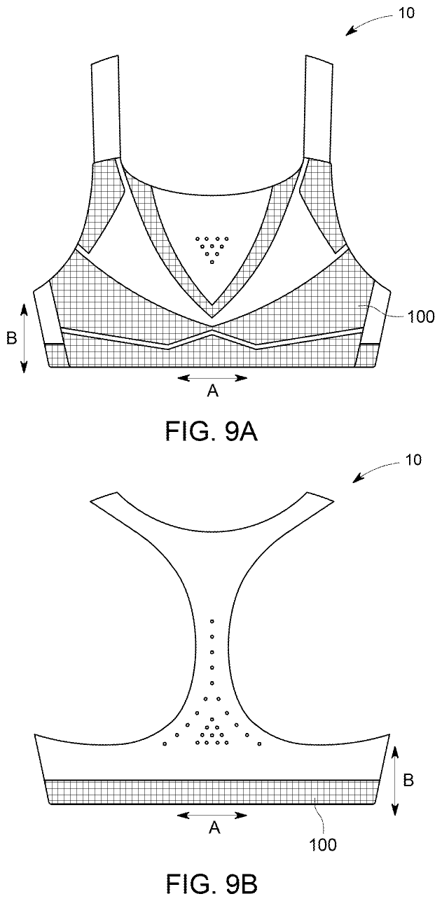

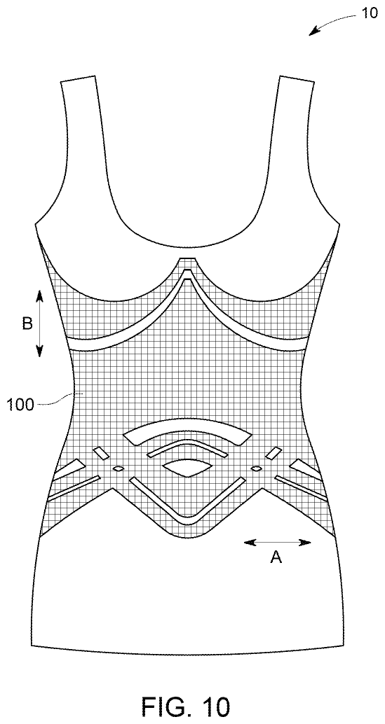

FIGS. 6-10 illustrate different examples of the article of clothing 10 which may utilize the elastic portion 100 of the present disclosure. In FIG. 6, the article of clothing 10 is shown to be an underwear, and the hatched region represents the elastic portion 100 therein. In this example, the elastic portion 100 is arranged along a waist line of the underwear 10 such that the first direction ‘A’ is along lateral direction and the second direction ‘B’ is along longitudinal direction of the waist line of the underwear 10. It may be appreciated that the elastic portion 100 has been arranged in that manner since the lateral direction of the waist line needs to provide better elasticity to be suitable for people with different body proportions and the longitudinal direction of the waist line needs to provide better support and stability. In some embodiments, the elastic portion 100 is a separate component from the rest of the article of clothing 10, and the elastic portion 100 is stitched or affixed by other suitable means, such as ultrasonic welding, to the rest of the article of clothing 10. In other embodiments, the first and second fabric layers 102, 104 are not separate from the rest of the article of clothing 10, and may span a part of or the whole of the dimensions of the article of clothing 10, in which case the hatched region corresponds to the extent of the elastic mesh 106 that is sandwiched between and of smaller dimensions with respect to the first and second fabric layers 102, 104. In FIG. 7, the article of clothing 10 is shown to be a short, and the hatched regions represent the elastic portions 100 therein. In this example, the elastic portions 100 are arranged along a waist line and hems of the short 10 such that the first direction ‘A’ is along lateral directions and the second direction ‘B’ is along longitudinal directions of the corresponding waist line and the hems so that the waist line and the hems provide better elasticity along the lateral directions, and better support and stability along the longitudinal directions thereof. In some embodiments, an elastic portion 100 is a separate component from the rest of the article of clothing 10, and the elastic portion 100 is stitched or affixed by other suitable means, such as ultrasonic welding, to the rest of the article of clothing 10. In other embodiments, the first and second fabric layers 102, 104 of an elastic portion 100 are not separate from the rest of the article of clothing 10, and may span a part of or the whole of the dimensions of the article of clothing 10, in which case the hatched region corresponds to the extent of the elastic mesh 106 that is sandwiched between and of smaller dimensions with respect to the first and second fabric layers 102, 104. In FIG. 8, the article of clothing 10 is shown to be a trouser, and the hatched region represents the elastic portion 100 therein. In this example, the elastic portion 100 is arranged along a waist line of the trouser 10 such that the first direction ‘A’ is along lateral direction and the second direction ‘B’ is along longitudinal direction of the waist line so that the waist line provides better elasticity along the lateral direction and better support and stability along the longitudinal direction. In some embodiments, the elastic portion 100 is a separate component from the rest of the article of clothing 10, and the elastic portion 100 is stitched or affixed by other suitable means, such as ultrasonic welding, to the rest of the article of clothing 10. In other embodiments, the first and second fabric layers 102, 104 are not separate from the rest of the article of clothing 10, and may span a part of or the whole of the dimensions of the article of clothing 10, in which case the hatched region corresponds to the extent of the elastic mesh 106 that is sandwiched between and of smaller dimensions with respect to the first and second fabric layers 102, 104. In FIGS. 9A and 9B, the article of clothing 10 is shown to be a sports bra with FIG. 9A showing the front side and FIG. 9B showing the back side thereof, and the hatched regions represent the elastic portions 100 therein. In this example, the elastic portions 100 are arranged along lower edge and cups of the sports bra 10 such that the first direction ‘A’ is along lateral directions and the second direction ‘B’ is along longitudinal directions of the corresponding lower edge and the cups so that the lower edge and the cups provide better elasticity along the lateral directions, and better support and stability along the longitudinal directions thereof. In some embodiments, an elastic portion 100 is a separate component from the rest of the article of clothing 10, and the elastic portion 100 is stitched or affixed by other suitable means, such as ultrasonic welding, to the rest of the article of clothing 10. In other embodiments, the first and second fabric layers 102, 104 of an elastic portion 100 are not separate from the rest of the article of clothing 10, and may span a part of or the whole of the dimensions of the article of clothing 10, in which case the hatched region corresponds to the extent of the elastic mesh 106 that is sandwiched between and of smaller dimensions with respect to the first and second fabric layers 102, 104. In FIG. 10, the article of clothing 10 is shown to be a corset, and the hatched regions represent the elastic portions 100 therein. In this example, the elastic portions 100 are arranged such that the first direction ‘A’ is generally along lateral/horizontal direction and the second direction ‘B’ is generally along longitudinal/vertical direction so that the corset provides better elasticity along the lateral direction to be suitable for people of different body proportions, and better support and stability along the longitudinal direction. In some embodiments, an elastic portion 100 is a separate component from the rest of the article of clothing 10, and the elastic portion 100 is stitched or affixed by other suitable means, such as ultrasonic welding, to the rest of the article of clothing 10. In other embodiments, the first and second fabric layers 102, 104 of an elastic portion 100 are not separate from the rest of the article of clothing 10, and may span a part of or the whole of the dimensions of the article of clothing 10, in which case the hatched region corresponds to the extent of the elastic mesh 106 that is sandwiched between and of smaller dimensions with respect to the first and second fabric layers 102, 104.

The presently disclosed elastic portion 100, with the elastic mesh 106 therein, allows the article of clothing 10 to expand and contract on application and removal, respectively, of force therefrom to make the article of clothing 10 suitable to worn by a person. The elastic portion 100 of the present disclosure can be utilized in any type of article of clothing, such as the article of clothing 10, which requires, at least in some section, more elasticity along one direction as compared to another direction. The more elastic direction corresponds to the location in the article of clothing 10 where it is desirable to have enhanced elasticity to fit the different sizes of different wearers. The less elastic direction corresponds to location in the article of clothing 10 where it is desirable to have relatively more support and stability. The implementation of elastic mesh 106 may provide desired directional elastic properties from the article of clothing 10, while possibly eliminating the need of using adhesives for securing the two fabric layers 102 and 104 in the elastic portion 100 thereof. The elastic mesh 106 in the elastic portion 100 also has the advantages of being light weight and cost-effective. Furthermore, the elastic mesh 106 with the plurality of openings, such as the plurality of rectangular openings 112, provides good ventilation in the elastic portion 100, and thereby in the section of the article of clothing 10 using the elastic portion 100. In some embodiments, the elastic portion 100 is a separate component from the rest of the article of clothing 10, and the elastic portion 100 is stitched or affixed by other suitable means, such as ultrasonic welding, to the rest of the article of clothing 10. In other embodiments, the first and second fabric layers 102, 104 are not separate from the rest of the article of clothing 10, and may span a part of or the whole of the dimensions of the article of clothing 10.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. An article of clothing comprising:
a first fabric layer;
a second fabric layer; and
an elastic mesh sandwiched between the first fabric layer and the second fabric layer, wherein the elastic mesh has higher elasticity along a first direction as compared to a second direction thereof.

2. The article of clothing of claim 1, wherein the elastic mesh comprises first threads arranged along the first direction and second threads arranged along the second direction, and wherein the first threads and the second threads crisscross each other to form the elastic mesh.

3. The article of clothing of claim 2, wherein the first threads are made of higher elasticity material and the second threads are made of comparatively lower elasticity material.

4. The article of clothing of claim 3, wherein the first threads are made of thermoplastic elastomers (TPE) material and the second threads are made of polyethylene (PE) material.

5. The article of clothing of claim 2, wherein the first threads have lower cross-sectional thickness as compared to the second threads.

6. The article of clothing of claim 5, wherein the second threads have 1.1 to 3 times of cross-sectional thickness as compared to the first threads.

7. The article of clothing of claim 2, wherein the first threads and the second threads crisscross each other in a manner to form a plurality of rectangular openings in the elastic mesh, and wherein sides of each of the plurality of rectangular openings extending along the first direction are shorter as compared to sides of each of the plurality of rectangular openings extending along the second direction.

8. The article of clothing of claim 7, wherein each of the plurality of rectangular openings in the elastic mesh have dimensions substantially equal to one of 3 mm by 5.5 mm, 1.5 mm by 2.5 mm and 1 mm by 1.2 mm.

9. The article of clothing of claim 1, wherein the elastic mesh has 1.1 to 3 times higher elasticity along the first direction as compared to the second direction thereof.

10. The article of clothing of claim 1, wherein the elastic mesh is heat sealed to one of the first fabric layer and the second fabric layer.

11. The article of clothing of claim 1, wherein the elastic mesh is heat sealed to both the first fabric layer and the second fabric layer, and thereby adheres the first fabric layer to the second fabric layer.

12. A method of manufacturing an article of clothing, the method comprising;
providing a first fabric layer and a second fabric layer;
providing an elastic mesh having higher elasticity along a first direction as compared to a second direction thereof; and
sandwiching the elastic mesh between the first fabric layer and the second fabric layer.

13. The method of claim 12 further comprising hot pressing the elastic mesh between the first fabric layer and the second fabric layer.

14. The method of claim 13, wherein the elastic mesh is heat sealed to one of the first fabric layer and the second fabric layer.

15. The method of claim 13, wherein the elastic mesh is heat sealed to both the first fabric layer and the second fabric layer, and thereby adheres the first fabric layer to the second fabric layer.

16. The method of claim 12, wherein the elastic mesh comprises first threads arranged along the first direction and second threads arranged along the second direction, and wherein the first threads and the second threads crisscross each other to form the elastic mesh.

17. The method of claim 16, wherein the first threads are made of higher elasticity material and the second threads are made of comparatively lower elasticity material.

18. The method of claim 16, wherein the first threads have lower cross-sectional thickness as compared to the second threads.

19. The method of claim 16, wherein the first threads and the second threads crisscross each other in a manner to form a plurality of rectangular openings in the elastic mesh, and wherein sides of each of the plurality of rectangular openings extending along the first direction are shorter as compared to sides of each of the plurality of rectangular openings extending along the second direction.

20. A brassiere, comprising:
a pair of bra cups; and
a pair of side wings joined to the pair of bra cups;
wherein one or more of the pair of bra cups and the pair of side wings comprises:
a first fabric layer;
a second fabric layer; and
an elastic mesh heat sealed to at least one of the first fabric layer and the second fabric layer, and sandwiched between the first fabric layer and the second fabric layer, wherein the elastic mesh has higher elasticity along a first direction as compared to a second direction thereof.
